(19) United States
(12) Patent Application Publication
(10) Pub. No.: US 2020/0186274 A1
(43) Pub. Date: Jun. 11, 2020

(54) OPTICAL DUPLEXER AND OPTICAL TRANSCEIVING SYSTEM

(71) Applicant: Chunghwa Telecom Co., Ltd., Taoyuan City (TW)

(72) Inventors: Hung-Huei Liao, Taoyuan City (TW); Chin-Wei Lin, Taoyuan City (TW)

(73) Assignee: Chunghwa Telecom Co., Ltd., Taoyuan City (TW)

(21) Appl. No.: 16/667,865

(22) Filed: Oct. 29, 2019

(30) Foreign Application Priority Data
Dec. 5, 2018 (TW) 107216575

(51) Int. Cl. H04J 14/02; H04B 1/52; G02B 6/293; H04B 10/25

(52) U.S. Cl. CPC H04J 14/0216; H04B 10/2503; G02B 6/2932; H04B 1/52

(57) ABSTRACT

An optical duplexer adapted to convert dual fiber bidirectional transmission into single fiber bidirectional wavelength or wavelength group transmission is provided. The optical duplexer includes an optical circulator, a first male fiber connector, a second female fiber connector, and a third male fiber connector. The optical circulator includes a first port, a second port, and a third port. The first port receives a first light signal. The second port transmits the first light signal and receives a second light signal. The third port transmits the second light signal. The first male fiber connector couples to the first port. The second female fiber connector couples to the second port. The third male fiber connector couples to the third port.

### CROSS-REFERENCE TO RELATED APPLICATION

This application claims the priority benefit of Taiwan application serial no. 107216575, filed on Dec. 5, 2018. The entirety of the above-mentioned patent application is hereby incorporated by reference herein and made a part of this specification.

### BACKGROUND OF THE DISCLOSURE

### Field of the Disclosure

The present disclosure relates to a device suitable for mounting an optical fiber or an optical cable, and particularly relates to an optical duplexer and an optical transceiving system.

### Description of Related Art

With the evolution of the optical communication technology, a fiber network has been regarded as an essential infrastructure for modern cities. Wavelength division multiplexing (WDM) is one of the mainstream communication technologies commonly used in optical communication systems. During the construction of the fiber network, a wavelength division multiplexer is required to realize the purpose of simultaneous transmission of multiple beams of lasers in different wavelengths on a single fiber by using multiple laser devices. However, the number of ports of the wavelength division multiplexer is fixed. When optical transceivers to be communicated by the fiber network increase beyond the number that the wavelength division multiplexer may support, telecom operators may need to spend additional cost and time to re-construct the fiber network. Furthermore, the construction of the fiber network may also cause the traffic interruption of the fiber network and cause inconvenience to users.

### SUMMARY OF THE DISCLOSURE

The present disclosure is directed to an optical duplexer adapted to convert dual fiber bidirectional transmission into single fiber bidirectional wavelength or wavelength group transmission. The optical duplexer includes an optical circulator, a first male fiber connector, a second female fiber connector, and a third male fiber connector. The optical circulator includes a first port, a second port, and a third port. The first port receives a first light signal. The second port transmits the first light signal and receives a second light signal. The third port transmits the second light signal. The first male fiber connector couples to the first port. The second female fiber connector couples to the second port. The third male fiber connector couples to the third port.

The present disclosure is directed to an optical transceiving system adapted to convert dual fiber bidirectional transmission into single fiber bidirectional wavelength or wavelength group transmission. The optical transceiving system includes an optical duplexer and a wavelength division multiplexer. The optical duplexer includes an optical circulator, a first male fiber connector, a second female fiber connector, and a third male fiber connector. The optical circulator includes a first port, a second port, and a third port. The first port receives a first light signal. The second port transmits the first light signal and receives a second light signal. The third port transmits the second light signal. The first male fiber connector couples to the first port. The second female fiber connector couples to the second port. The third male fiber connector couples to the third port. The wavelength division multiplexer includes a fourth port and a fifth port. The fourth port couples to the second port, and receives the first light signal and transmits the second light signal. The fifth port transmits the first light signal and receives the second light signal.

Based on the above, the optical duplexer of the present disclosure may amplify users of a fiber network without changing an existing fiber network architecture.

In order to make the aforementioned and other objectives and advantages of the present disclosure comprehensible, embodiments accompanied with figures are described in detail below.

### BRIEF DESCRIPTION OF THE DRAWINGS

FIG. 1 is a schematic diagram of an optical duplexer according to an embodiment of the present disclosure.

FIG. 2 is a schematic diagram of an optical transceiving system according to an embodiment of the present disclosure.

FIG. 3 is a schematic diagram of another optical transceiving system according to an embodiment of the present disclosure.

### DESCRIPTION OF THE EMBODIMENTS

The present disclosure provides an optical duplexer. The optical duplexer is a passive component which may be externally connected to a fiber cable. By additionally arranging the optical duplexer, two light signals which are unidirectionally transmitted on different fiber cables respectively may be bidirectionally transmitted on a single fiber cable. Therefore, a fiber network which originally supports only one user may be immediately upgraded to support two users.

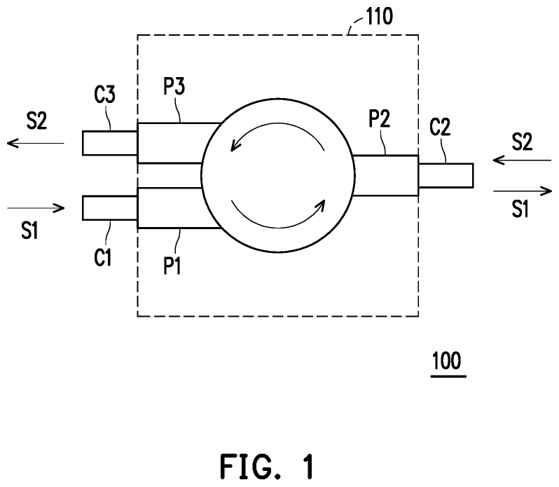

FIG. 1 is a schematic diagram of an optical duplexer 100 according to an embodiment of the present disclosure. The optical duplexer 100 may include an optical circulator 110. The optical circulator 110 has three ports, namely a first port P1, a second port P2, and a third port P3 respectively. The optical circulator 110 has the functions of unidirectional input of the first port P1, bidirectional input/output of the second port P2, and unidirectional output of the third port P3.

Specifically, the first port P1 is configured to receive (or input) a first light signal S1. For example, the first port P1 may couple to a transmitting end of a terminal device of a user, and receives the first light signal S1 from the terminal device of the user from the transmitting end. The second port P2 is configured to transmit the first light signal S1 and receive a second light signal S2. For example, the second port P2 may couple to a transceiver or a wavelength division multiplexer. The second port P2 may transmit the first light signal S1 to the transceiver or the wavelength division multiplexer through a fiber cable, and receives the second light signal S2 from the transceiver or the wavelength division multiplexer through the same fiber cable. The third port P3 is configured to transmit (or output) the second light signal S2. For example, the third port P3 may couple to a receiving end of a terminal device of a user, and transmits the second light signal S2 to the receiving end of the terminal device of the user.

In an embodiment, the optical duplexer 100 may further include a first male fiber connector C1, a second female fiber connector C2, and a third male fiber connector C3. The first male fiber connector C1 couples to the first port P1. The second female fiber connector couples to the second port P2. The third male fiber connector couples to the third port P3. The first male fiber connector C1, the second female fiber connector C2 and the third male fiber connector C3 may be respectively provided with ceramic ferrules.

In an embodiment, the first male fiber connector C1 and the third male fiber connector C3 are arranged on one side of the optical circulator 110 in parallel, as shown in FIG. 1, but the present disclosure is not limited thereto.

In an embodiment, the first male fiber connector C1, the second female fiber connector C2 and the third male fiber connector C3 respectively may be a common type of fiber connector, such as a standard connector (SC), a Lucent/local connector (LC), an enterprise systems connection (ESCON), a ferrule connector (FC), a fiber distributed data interface (FDDI), a mechanical transfer (MT), or a straight tip (ST) connector, or the like, but the present disclosure is not limited thereto.

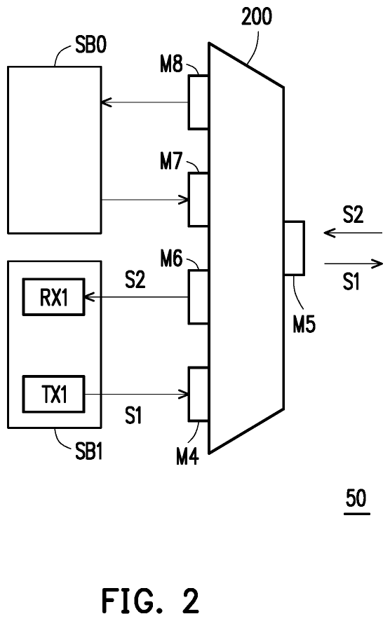

FIG. 2 is a schematic diagram of an optical transceiving system 50 according to an embodiment of the present disclosure. The optical transceiving system 50 may include a wavelength division multiplexer 200. In the present embodiment, the wavelength division multiplexer 200 may have a fourth port M4 and a sixth port M6 that may serve as input ports, and a fifth port M5 that may serve as an output port. However, the present disclosure is not limited thereto. For example, if the wavelength division multiplexer 200 is a four-to-one wavelength division multiplexer, input ports of the wavelength division multiplexer 200 may also include an input port M7 and an input port M8 in addition to the fourth port M4 and the sixth port M6, as shown in FIG. 2.

The wavelength division multiplexer 200 may couple to a transceiver SB1 and/or a transceiver SB0. Taking the transceiver SB1 as an example, specifically, the fourth port M4 may couple to a transmitting end TX1 of the transceiver SB1, and receives a first light signal S1 from the transceiver SB1. The fifth port may transmit the first light signal S1 to an external device through a fiber cable, and receives a second light signal S2 from the external device through the same fiber cable. The sixth port M6 may couple to a receiving end RX1 of the transceiver SB1, and transmits the second light signal S2 to the transceiver SB1.

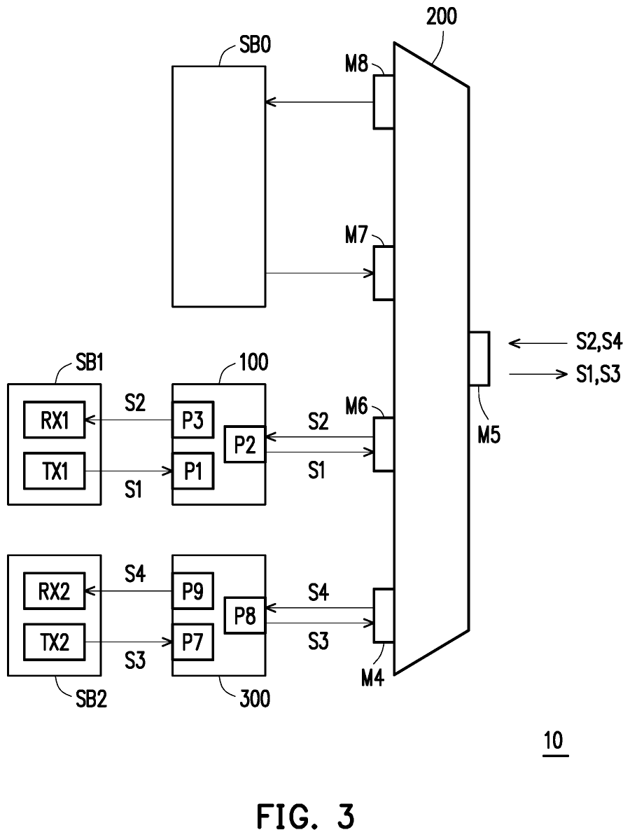

Assuming that a person wants to increase the number of transceivers supported by the wavelength division multiplexer 200, the person may mount the optical duplexer 100 of the present disclosure between the wavelength division multiplexer 200 and the transceiver. Therefore, a transmitting end and a receiving end of a single transceiver may use the ports of the same wavelength division multiplexer 200, as shown in FIG. 3.

FIG. 3 is a schematic diagram of another optical transceiving system 10 according to an embodiment of the present disclosure. The optical transceiving system 10 may include a wavelength division multiplexer 200 and an optical duplexer 100 (as shown in FIG. 1). In the present embodiment, the wavelength division multiplexer 200 may have a fourth port M4 and a sixth port M6 that may serve as input ports, and a fifth port M56 that may serve as an output port. However, the present disclosure is not limited thereto. For example, if the wavelength division multiplexer 200 is a four-to-one wavelength division multiplexer, input ports of the wavelength division multiplexer 200 may also include an input port M7 and an input port M8 in addition to the fourth port M4 and the sixth port M6, as shown in FIG. 3. In an embodiment, the optical transceiving system 10 may further include an optical duplexer 300. The structure and function of the optical duplexer 300 are the same as those of the optical duplexer 100, and a seventh port P7, an eighth port P8 and a ninth port P9 of the optical duplexer 300 respectively correspond to the first port P1, the second port P2 and the third port P3 of the optical duplexer 100.

The transmitting end TX1 of the transceiver SB1 couples to the first port P1 of the optical duplexer 100, and transmits the first light signal S1 representing an uplink signal of the transceiver SB1 to the first port P1. The receiving end RX1 of the transceiver SB1 couples to the third port P3 of the optical duplexer 100, and receives the second light signal S2 representing a downlink signal of the transceiver SB1 from the third port P3. The second port P2 of the optical duplexer 100 may couple to one of the fourth port M4 and the sixth port M6 of the wavelength division multiplexer 200, and transmits the first light signal S1 and receives the second light signal S2 through a single fiber cable. In FIG. 3, the second port P2 of the optical duplexer 100 couples to the sixth port M6 of the wavelength division multiplexer 200, but the present disclosure is not limited thereto.

In general, a port of a wavelength division multiplexer only supports a single wavelength. Therefore, under the condition that a transmitting end and a receiving end of a single transceiver need to respectively use different ports, the wavelength of a light signal transmitted by the transmitting end of the transceiver needs to be different from the wavelength of a light signal received by the receiving end of the transceiver. However, as can be seen from FIG. 3, the transmitting end TX1 and the receiving end RX1 of the transceiver SB1 may couple to the same port (namely the sixth port M6) of the wavelength division multiplexer 200 through the optical duplexer 100 of the present disclosure. In other words, after the optical duplexer 100 is mounted, the transceiver SB1 which originally needs to occupy two ports of the wavelength division multiplexer 200 (as shown in FIG. 2) only needs to occupy one port of the wavelength division multiplexer 200, and the wavelength of the first light signal S1 may be the same as that of the second light signal S2.

Based on the above, the person may apply the other port released from the wavelength division multiplexer 200 to the newly added transceiver SB2. Specifically, a transmitting end TX2 of the transceiver SB2 couples to the seventh port P7 of the optical duplexer 300, and transmits the third light signal S3 representing an uplink signal of the transceiver SB2 to the seventh port P7. A receiving end RX2 of the transceiver SB2 couples to the ninth port P9 of the optical duplexer 300, and receives a fourth light signal S4 representing a downlink signal of the transceiver SB2 from the ninth port P9. The eighth port P8 of the optical duplexer 300 may couple to one of the fourth port M4 and the sixth port M6 of the wavelength division multiplexer 200, and transmits the third light signal S3 and receives the fourth light signal S4 through a single fiber cable. In FIG. 3, the eighth port P8 of the optical duplexer 300 couples to the fourth port M4 of the wavelength division multiplexer 200, but the present disclosure is not limited thereto.

In conclusion, the optical duplexer 100 and the optical transceiving system 10 of the present disclosure have the following characteristics and effects: 1. There is no need to change any existing optical network construction. 2. The optical duplexer 100 is a passive component that does not require any additional power supply. 3. The transceiver only needs to be additionally provided with the optical duplexer 100 to convert dual fiber bidirectional transmission into single fiber bidirectional transmission. 4. The number of required transferred transceivers may be locally increased or reduced in real time without collective amplification so as to avoid traffic interruption. 5. There is no limit of bidirectional transmission use wavelength, and the same wavelength may be used for bidirectional transmission, so that the wavelength use sorting is simplified, and the defects of complicated WDM wavelength planning and difficult management are overcome. 6. Any optical network of dual fiber bidirectional wavelength or wavelength group transmission may be converted into an optical network of single fiber bidirectional wavelength or wavelength group transmission. 7. There is no need to additionally mount any WDM coupler, and the original fiber network may be increased to 2 times the use number of the same wavelength of WDM, so that compared with the traditional WDM transmission, a half of WDM couplers and access fibers may be reduced. 8. The problem of limitation of the number of WDM wavelength channels is solved, and the use number of the wavelength may be increased by 2 times without constructing new fibers. 9. The construction cost and the engineering time are effectively reduced.

The optical duplexer of the present disclosure may be mounted on the existing fiber cable, so that two light signals which are unidirectionally transmitted on different fiber cables respectively may be bidirectionally transmitted on a single fiber cable. Therefore, a transmitting end and a receiving end of a light transceiver may together use ports of a single wavelength division multiplexer. In other words, the present disclosure may amplify users of the fiber network without changing an existing fiber network architecture.

Although the disclosure is described with reference to the above embodiments, the embodiments are not intended to limit the disclosure. A person of ordinary skill in the art may make variations and modifications without departing from the spirit and scope of the disclosure. Therefore, the protection scope of the disclosure should be subject to the appended claims.

What is claimed is:

1. An optical duplexer, adapted to convert dual fiber bidirectional transmission into single fiber bidirectional wavelength or wavelength group transmission, comprising:
an optical circulator, comprising:
a first port, receiving a first light signal;
a second port, transmitting the first light signal and receiving a second light signal; and
a third port, transmitting the second light signal;
a first male fiber connector, coupling to the first port;
a second female fiber connector, coupling to the second port; and
a third male fiber connector, coupling to the third port.

2. The optical duplexer according to claim 1, wherein the first light signal has a first wavelength, the second light signal has a second wavelength, and the first wavelength is the same as the second wavelength.

3. The optical duplexer according to claim 1, wherein the first male fiber connector, the second female fiber connector and the third male fiber connector are respectively provided with ceramic ferrules.

4. The optical duplexer according to claim 1, wherein the first male fiber connector, the second female fiber connector and the third male fiber connector are respectively one of a standard connector and a Lucent/local connector.

5. The optical duplexer according to claim 1, wherein the first male fiber connector and the third male fiber connector are arranged on one side of the optical circulator in parallel.

6. An optical transceiving system adapted to convert dual fiber bidirectional transmission into single fiber bidirectional wavelength or wavelength group transmission, the optical transceiving system comprising:
an optical duplexer, comprising:
an optical circulator, comprising:
a first port, receiving a first light signal;
a second port, transmitting the first light signal and receiving a second light signal; and
a third port, transmitting the second light signal;
a first male fiber connector, coupling to the first port;
a second female fiber connector, coupling to the second port; and
a third male fiber connector, coupling to the third port; and
a wavelength division multiplexer, comprising:
a fourth port, coupling to the second port, the fourth port receiving the first light signal and transmitting the second light signal; and
a fifth port, transmitting the first light signal and receiving the second light signal.
